(19) United States
(12) Patent Application Publication
(10) Pub. No.: US 2005/0055579 A1
(43) Pub. Date: Mar. 10, 2005

(54) Server apparatus, and method of distributing a security policy in communication system

(76) Inventors: Mitsuru Kanda, Tokyo (JP); Yuzo Tamada, Yokohama-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/921,203

(22) Filed: Aug. 19, 2004

(30) Foreign Application Priority Data
Aug. 21, 2003 (JP) 2003-208272

(51) Int. Cl. H04L 9/00

(52) U.S. Cl. 713/201; 713/150

(57) ABSTRACT

A server comprises a server memory to store data indicating a plurality of different security policies necessary for communications in a network, a server receiver to receive a request message for requesting transmission of data of a security policy from a host computer, and a server transmitter to transmit a notification message including data of the security policy in response to the request message.

### CROSS-REFERENCE TO RELATED APPLICATIONS

This application is based upon and claims the benefit of priority from prior Japanese Patent Application No. 2003-208272, filed Aug. 21, 2003, the entire contents of which are incorporated herein by reference.

### BACKGROUND OF THE INVENTION

1. Field of the Invention

The present invention relates to a server apparatus, and a method of distributing security setting information of a host computer joining a network such as Internet or intranet.

2. Description of the Related Art

It is thought that the communication mode of Internet shifts to end-to-end communication by introduction of IPv6 (Internet Protocol Version 6) which is a next generation technique. With the assumption that communications apparatuses communicate directly to each other, a guarantee of security in each communication channel is more and more necessary. There is IPsec (IP security Protocol) as a technique to realize the security guarantee in the communication channel. IPsec is a security protocol to provide authentication and encryption in a network layer in OSI reference model, and standardized in an Internet Engineering Task Force (IETF). A communications apparatus with an IPsec function can provide authentication of destination communications apparatus, and safety and security of communication data.

When performing communications using IPsec, it is necessary to match a communications source with a communications destination on a security class such as what kind of authentication algorithm or encryption algorithm should be used or what kind of encryption key should be used. This matching is realized by SA (Security Association) in IPsec.

The communications apparatus with an IPsec function holds an information group which defines Internet address information to distinguish a destination communications apparatus applying security, information to indicate whether or not IPsec should be applied, information to indicate which security protocol should be applied. Also, it has an access restraint function. In IPsec, this information group is realized by a security policy (SP) (referred to as IETF IPsec Policy Information Base, January 2003).

The concept of the security policy is not limited to the above case. As a measure to ensure security in end-to-end communications is thought the following method. It is a measure to pass only a particular packet such as a firewall. This can realize security of a network by blocking an access between a network to which a communications apparatus belongs to and an external network. Alternatively, concealing an address of a gateway or a router which is arranged on the network makes it possible to ensure communications between the self-network and the external network. In this case, the transmission to the external becomes impossible, resulting in that danger of data leak and the like can be reduced.

Conventionally, for the purpose of setting a security policy of IPsec to a security policy database of the communications apparatus, it is necessary that an administrator of a communications apparatus joining a network or a user thereof sets manually the security policy to the database. Alternatively, if a distribution method is a prescribed security method, it is necessary to refer to individually the security policy servers installed according to security methods, respectively. Even if the latter method can employ, it is not found whether there is a security policy server. Even if it was found, a reference destination (IP address, for example) may not be unified every network.

A book-size personal computer or PDA (Personal Digital Assistant) which may be connected often to different networks must be subjected to a security policy setting whenever it starts a new connection while moving between network links. The latter method as well as the former method has a problem that a work to change a reference destination every network is complicated for a user.

It is an object of the present invention to provide a communication system which is able to acquire security policy information necessary for communications in a connection destination network link without assistance, and reduce an operation load of security policy distribution, a method of distributing a security policy in the communication system, and a server apparatus.

### BRIEF SUMMARY OF THE INVENTION

An aspect of the invention provides a server apparatus connected to a network and a host computer via the network, comprising: a server memory to store data indicating a plurality of different security policies necessary for communications in the network; a server receiver to receive a request message for requesting transmission of data of a security policy from the host computer; and a server transmitter to transmit a notification message including data of the security policy in response to the request message.

Another aspect of the invention provides a server apparatus connected to a network, comprising: a server memory to store security policy data indicating a plurality of security policies necessary for communications in the network, and a server transmitter to transmit a notification message including the security policy data to a multicast address periodically or when contents stored in the server memory changes.

Another aspect of the invention provides a method of distributing a security policy to a network, comprising: connecting a security policy server storing data indicating a plurality of different security policies necessary for communications in the network to the network; requesting transmission of data of a security policy to the security policy server; and transmitting a notification message including the data of the security policy from the security policy server to a multicast address in response to the requesting.

Another aspect of the invention provides a method of distributing a security policy to a network, comprising: connecting a security policy server storing security policy data indicating a plurality of security policies necessary for communications in the network, and transmitting a notification message including the security policy data to a multicast address periodically or when contents stored in the server memory changes.

### BRIEF DESCRIPTION OF THE SEVERAL VIEWS OF THE DRAWING

FIG. 1 is a schematic diagram illustrating the whole network wherein a network link having a communication system related to an embodiment of the present invention and another network link are connected to each other;

FIG. 2 is a block diagram illustrating a schematic configuration of the communication system related to the embodiment of the present invention;

FIG. 3 is a diagram illustrating the functional elements of a security policy server comprising the communication system related to the embodiment along with the state transition thereof;

FIG. 4 is a diagram illustrating the functional elements of a host computer comprising the communication system related to the embodiment along with the state transition thereof;

FIG. 5 is a diagram for explaining an operation example of the communication system of the embodiment, and shows a state that a security policy notification message is subjected to multicasting;

FIG. 6 is a diagram for explaining an operation example of the communication system of the embodiment, and shows a state that a security policy request message is subjected to multicasting; and

FIG. 7 is a diagram for explaining an operation example of the communication system of the embodiment, and shows a state that a security policy notification message is subjected to multicasting in response to the security policy request message.

### DETAILED DESCRIPTION OF THE INVENTION

There will now be described an embodiment of the present invention in conjunction with the accompanying drawings.

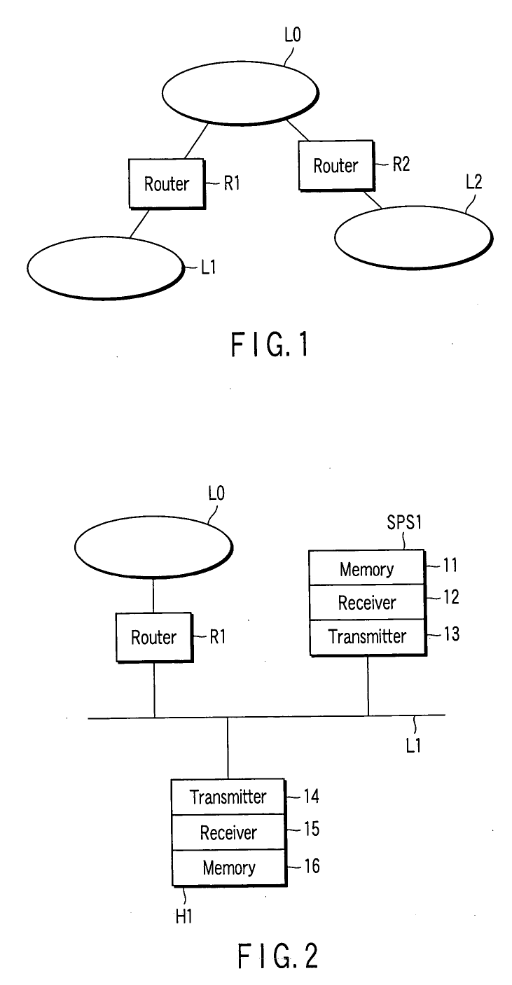

FIG. 1 is a schematic diagram illustrating the whole network wherein a network link having a communication system related to an embodiment of the present invention and another network link are connected to each other. In FIG. 1, a communication system related to the embodiment of the present invention is built on, for example, a network link L1. A network link L0 connected to the network link L1 through a router R1 and a network link L2 connected to the network link L0 through a router R2 both are connected to the network link L1 through the router R1, and differ in a network or a network link from each other.

FIG. 2 is a block diagram illustrating a schematic structure of the communication system related to the embodiment of the present invention. As shown in this FIG. 2, the router R1, a security policy server SPS1 and a host computer (a node) H1 are connected to the network link L1. The security policy sever SPS1 includes a memory (security policy database) 11 to store security policy information representing a plurality of different security-policies necessary for communications in the network L1, a receiver module 12 to receive a request message for requesting transmission of data of a security policy, and a transmitter module 13 to transmit a notification message including data of the security policy in response to the request message.

The host computer H1 includes a transmitter module 14 to transmit the request message to a server multicast address of the server SPS1, a receiver module 15 to receive the notification message from the server SPS1, and a memory 16 to store data of a security policy included in the notification message received by the host receiver.

The router R1, the security policy server SPS1, and the host computer H1 each comprises a communications apparatus including a computer providing with a network function. The arbitrary number of communication apparatuses may be connected to the network link L1. The router R1 may be a security gateway. The router (or security gateway) R1 and the security policy server SPS1 may comprise a physically identical apparatus. The network link L1 comprises a network configured with a physical layer of, for example, an Ethernet (trademark) and an upper layer of TCP/IP.

In the present embodiment, assuming that in the network link L1 a packet communication is carried out through IPsec (IP security Protocol) standardized in an Internet Engineering Task Force (IETF). IPsec is a security protocol to provide authentication and encryption in a network layer in an OSI reference model. The packet exchanged between the communications apparatuses connected to the network link L1 is encrypted at the time of transmitting. This encrypted packet is decoded by a communications apparatus of a receiving destination. Then, an authentication process of a communications apparatus for transmitting the encrypted packet is carried out, too. As thus described, the communications apparatus provided with the IPsec function realizes authentication of the communications apparatus, and safety and secrecy of communication data are enabled.

In the network link L1, two multicast addresses to set the link L1 to a local scope are defined. The two multicast addresses are effective only within the link L1. It is essential that the two multicast addresses are well known.

The first multicast address is the “all-nodes multicast address” that all nodes in the local scope of the network link L1 join. When the security policy server SPS1 notifies the host computer H1 connected to the network link L1 of a message of security policy information, the all-nodes multicast address is a multicast address designated to the destination. That a node joins the multicast means that the node can receive an IP packet addressed to the multicast.

The second multicast address is the “all-security-policy-servers multicast address” that all security policy servers in the local scope of the network link L1 join. When the host computer H1 notifies the security policy server SPS1 connected to the network link L1 of a message, the all-security-policy-servers multicast address is a multicast address designated to the destination thereof.

As described above, the all-security-policy-servers multicast address is known. This situation is essential. Of course, the host computer H1 has to know the all-security-policy-servers multicast address. However, the host computer H1 may not know IP address of the security policy server SPS1 joining the all-security-policy-server multicast address in communication of security policy information.

As messages used for automating the setting of a security policy related to the embodiment of the present invention are defined a security policy request message and a security policy notification message. The kinds of these messages may be realized by the types of ICMPv6 (Internet Control Message Protocol Version 6).

(Security Policy Server Notification Message)

A security policy server notification message is a message to notify of security policy information in the network link L1 from the security policy server SPS1. Usually, the message is transmitted to the all-nodes multicast address of the link local scope at a constant interval. However, if the security policy server request message described hereinafter is transmitted beforehand by the host computer Hi, there is a case that a security policy server notification message is transmitted not by a multicast but by a unicast.

The security policy information notified by a security policy server notification message is set to a security policy database of each of the communications apparatuses using IPsec.

As described above, when communications using IPsec are carried out, it is necessary to take matching between the communication source and communication destination on a security class concerning what kind of authentication algorithm or encryption algorithm is used or what kind of encryption key is used. This matching is realized by SA (Security Association) in IPsec.

The communications apparatus provided with an IPsec function holds an information group defining Internet address information for distinguishing a destination communications apparatus applying security, information applying IPsec, and information indicating which security protocol should be applied, and the like. The communications apparatus also has an access specification function. In IPsec, the information group is realized by a security policy (SP). Data corresponding to such security policy information is described in a data field of a security policy server notification message.

(Security Policy Server Request Message)

A security policy server request message is a message for requesting transmission of a security policy server notification message to the security policy server SPS1 of the network link L1

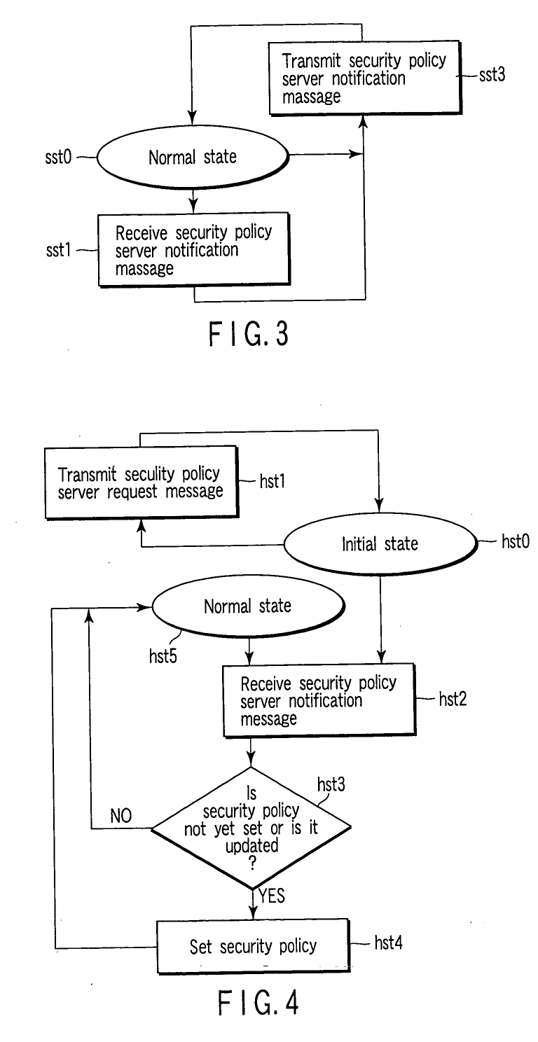

FIG. 3 is a diagram indicating functional elements of a security policy server configuring the communication system related to the present embodiment along with the state transition thereof. The security policy server SPS1 shown in FIG. 2 has a function of transmitting a security policy server notification massage to the all-nodes multicast address, periodically or when the re-notice such as the change of the security policy to be stored is necessary. The security policy server SPS1 also has a function of receiving a security policy server request message transmitted to the all-security-policy-server multicast address from any one of host computers, and transmitting a security policy server notification message in response to the request message.

The functional elements can be realized by a computer program to be executed on the security policy server SPS1. When this program is executed, at first the security policy server SPS1 changes to steady-state sst0 as shown in FIG. 3. In this condition, when a constant time passes, a timer event occurs, and the server SPS1 changes to status sst3 transmitting a security policy server notification message. If the server SPS1 transmits the security policy server notification message in status sst3, it changes to steady-state sst0, again. If the server SPS1 receives a security policy server request message, in steady-state sst0, it changes to status sst1 for subjecting the message to a receiving process. Then, the server SPS1 changes to status sst3 for transmitting the security policy server notification message in response to the request message.

In the present embodiment, the security policy server SPS1 assumes to determine a security policy within the network link L1. In other words, a network administrator or a system administrator assumes to set a security policy in the policy server SPS1. This set security policy is effective in the network link L1, and transmitted by multicasting to all nodes (communications apparatuses) in the link L1 according to the security policy server notification message.

Not the security policy server SPS1 but rather the other security policy server (not shown) may be connected to the link L1, to determine a security policy.

FIG. 4 is a diagram illustrating the functional elements mounted on the host computer configuring the communication system concerning the present embodiment along with their state transition. The host computer H1 shown in FIG. 2 has a function for transmitting a security policy server request message to the all-security-policy-servers multicast address, and a function for receiving the security policy server notification message transmitted to the all-nodes multicast address or the IP address of the host computer H1 and setting a security policy by analyzing its contents.

The function for transmitting the security policy server request message is not always necessary in the case of the following. For example, even if the security policy server SPS1 does not receive a security policy server request message from the host computer H1, it may multicast a security policy server notification message periodically or at necessary timing. As thus described, a desired effect can be obtained even if the request message is not transmitted from the host computer H1.

The functional elements can be realized by a computer program executable on the host computer H1. When this program is executed, the security policy server SPS1 changes to initial state hst0 as shown in FIG. 4. In this initial state hst0, the security policy server SPS1 changes to state hst1 automatically or according to a designation from an operator, and transmits a security policy server request message for requesting to transmit a security policy server notification message to any one of the security policy servers. If the security policy server SPS1 transmits the request message, it returns to the initial state hst0.

If the security policy server SPS1 receives a security policy server notification message in the initial state hst0, it changes to state hst2 for subjecting the message to a receiving process. Then, it changes to status hst3. In this status hst3, the security policy server SPS1 refers to the security policy database (not shown) in the host computer H1, and determines whether or not the security policy data described in the security policy notification message subjected to the receiving process in the state hst2 is unset to the security policy database. If the determination result in this status hst3 is YES, the security policy server SPS1 changes to state hst4 to write the security policy data in the security policy database.

If the determination result in the state hst3 is Yes, it is a case where security policy data is not stored in the security policy database at all and a case where the currently received security policy data is new than that stored in the security policy database. If the determination result in the state hst3 is No, that is, updating of the security policy database is unnecessary, the security policy server SPS1 changes to a steady-state of state hst5. In addition, the security policy server SPS1 changes to the steady-state of state hst5 after setting the security policy in state hst4, too.

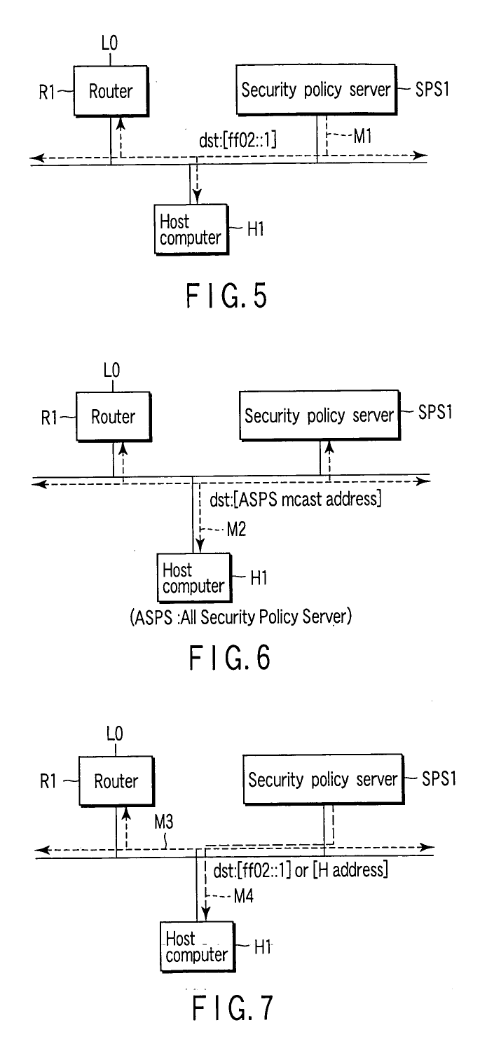

An operation example of the communication system related to the present embodiment will be described in conjunction with FIGS. 5-7.

In a first operation example, when the host computer H1 is connected to the network link L1, the host computer H1 waits for a security policy notification message transmitted to the all-nodes multicast address from the security policy server SPS1 periodically or at the time when notification is necessary again. Then, the security policy server SPS1 transmits a security policy notification message M1 to the all-nodes multicast address (dst: [ff02::1]) as shown in FIG. 5. The host computer H1 receives this notification message M1.

In the second operation example, when the host computer H1 is connected to the network link L1, it transmits a security policy request message M2 to the all-security-policy-servers multicast addresses immediately as shown in FIG. 6. This request message promotes to transmit a security policy notification message to security policy servers joining the all-security-policy-servers multicast address without specifying IP address.

The security policy server SPS1 transmits a security policy notification message M3 in response to the security policy request message M2 as shown in FIG. 7. The security policy notification message M3 is equivalent in contents to the security policy notification message M1 in the first operation example.

The security policy server SPS1 may transmit the security policy notification message M3 in a unicast by designating the IP address of the host computer H1 because the IP address of the host computer H1 can be specified by the security policy request message M2. Of course, the security policy server SPS1 may transmit the security policy notification message M3 in multicast to the all-nodes multicast address (dst: [ff02::1]) like the security policy notification message M1.

In the first operation example, if the host computer cannot receive the security policy notification message for a while when it is connected to the network, the host transmitter may transmit the request message after a give time (several minutes) from when the host computer is connected to the network.

In either of the first and second operation examples, the host computer H1 sets a security policy of IPsec according to the operation example described referring to FIG. 4 after reception of the security policy notification message. In the case where a security policy notification message cannot be received even if a given long time passes, the host computer H1 cannot do automatic setting of a security policy of IPsec. Accordingly, the host computer H1 sets the security policy according to a security policy established by a user of the host computer H1 or an administrator thereof beforehand.

In the case where a plurality of security policy servers exist on the identical network link L1, and the host computer H1 receives a different security policy notification message from each of the security policy servers, the security policy notification message may include an unjust notice. For this reason, the host computer H1 accords to not an automatic setting but a security policy established by a user of the host computer H1 or an administrator thereof beforehand. However, if any one of the security policy notification messages is signed by a public key, and data integrity and safety are recognized by an authentication result, the host computer H1 sets automatically the security policy according to the contents of the security policy notification message.

According to the present embodiment described above, even if IP address of the security policy server SPS1 is unclear, the host computer H1 can automatically set the security policy of IPsec. Consequently, a complicated work for the security policy setting needed when a network of a link destination changes can be reduced.

It is possible to contain information required for passing though a gateway, a router or a firewall alone or along with information employed in IPsec in the security policy notification message distributed by the embodiment.

In a concrete example, a destination address of gateways and the like, a port number thereof, a log-on ID/password thereof, a cryptic key used for ciphering communication data between gateways and the like.

According to the above configuration, it becomes possible to distribute easily various information necessary for communication through a network without a user and an administrator.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A server apparatus connectable to a network, comprising:
a server memory to store data indicating a plurality of different security policies necessary for communications in the network;
a server receiver to receive a request message for requesting transmission of data of a security policy; and
a server transmitter to transmit a notification message including the data of the security policy in response to the request message.

2. A communication system comprising:
at least one host computer connectable to the network and to, via the network, at least one server including the server according to claim 1 whose address is unclear for the host computer, the host computer including a host transmitter to transmit the request message to a server multicast address of the server, a host receiver to receive the notification message from the server, and a host memory to store data of a security policy included in the notification message received by the host receiver, the host computer performing communication according to data of the security policy stored in the host memory.

3. The communication system-according to claim 2, wherein the server transmitter includes means for transmitting, in response to the request message, the notification message to an address of the host computer specified by a host multicast address receivable by the host computer or a transmission source address included in a packet of the request message received by the server receiver.

4. The communication system according to claim 2, wherein the host transmitter transmits the request message when the host computer is connected to the network.

5. The communication system according to claim 2, wherein the server transmitter transmits the notification message to the host multicast address by ciphering and signing it in a public key, and the host receiver receives the ciphered notification message and decodes it and authenticates it based on the public key.

6. A server apparatus connectable to a network, comprising:
a server memory to store security policy data indicating a plurality of security policies necessary for communications in the network, and
a server transmitter to transmit a notification message including the security policy data to a multicast address periodically or when contents stored in the server memory changes.

7. A communication system comprising:
at least one host computer connectable to the network and to at least one server including the server according to claim 6 via the network, the host computer including a host receiver to receive the notification message addressed to the multicast address, a host memory to store data of a security policy included in the notification message, the host computer performing communication according to the data of the security policy stored in the host memory.

8. The communication system according to claim 7, wherein the server transmitter transmits the notification message to the multicast address by ciphering and signing it in a public key, and the host receiver receives the ciphered notification message and decodes it and authenticates it based on the public key.

9. The communication system according to claim 7, wherein the host computer includes a host transmitter to transmit a request message for requesting transmission of the data of the security policy to a server multicast address of the server, and the server includes a server receiver that receives the request message to transmit the notification from the sever transmitter in response to the request message.

10. The communication system according to claim 9, wherein the host transmitter transmits the request message after a give time from when the host computer is connected to the network.

11. The communication system according to claim 10, wherein the server transmitter transmits the notification message to the host multicast address by ciphering and signing it in a public key, and the host receiver receives the ciphered notification message and decodes it and authenticates it based on the public key.

12. A method of distributing a security policy to a network, comprising:
connecting a security policy server storing data indicating a plurality of different security policies necessary for communications in the network to the network;
requesting transmission of data of a security policy to the security policy server; and
transmitting a notification message including the data of the security policy from the security policy server to a multicast address in response to the requesting.

13. The method according to claim 12, wherein the requesting includes requesting the data of the security policy by at least one host computer connectable to the network and to, via the network, at least one server including the server whose address is unclear for the host computer, and the transmitting includes transmitting the notification message to the host computer.

14. The method according to claim 13, wherein the transmitting includes transmitting, in response to the request message, the notification message to an address of the host computer specified by a host multicast address receivable by the host computer or a transmission source address included in a packet of the request message.

15. The method according to claim 13, wherein the host transmitter transmits the request message when the host computer is connected to the network.

16. The method according to claim 13, wherein the transmitting includes transmitting the notification message to the host multicast address by ciphering and signing it in a public key.

17. A method of distributing a security policy to a network, comprising:
connecting a security policy server storing security policy data indicating a plurality of security policies necessary for communications in the network, and
transmitting a notification message including the security policy data to a multicast address periodically or when contents stored in the server memory changes.

18. The method according to claim 17, wherein the transmitting includes transmitting the notification message to the multicast address of at least one host computer connectable to the network and to at least one server including the server via the network.

19. The method according to claim 18, wherein the transmitting includes transmitting the notification message to the multicast address by ciphering and signing it in a public key.

20. The method according to claim 18, which includes transmitting a request message for requesting transmission of the data of the security policy to a server multicast address of the server after a give time from when the host computer is connected to the network.
